(19) United States
(12) Patent Application Publication
(10) Pub. No.: US 2008/0242469 A1
(43) Pub. Date: Oct. 2, 2008

(54) LOCKABLE DIFFERENTIALS

(75) Inventors: Kevin Jenski, Mukilteo, WA (US); Carl Schmidt, Lake Forest Park, WA (US); David Dee, Granite Falls, WA (US)

Correspondence Address: BLACK LOWE & GRAHAM, PLLC, 701 FIFTH AVENUE, SUITE 4800, SEATTLE, WA, 98104, US

(73) Assignee: Randy's Ring & Pinion, Everett, WA (US)

(21) Appl. No.: 11/691,250

(22) Filed: Mar. 26, 2007

(51) Int. Cl. F16H 48/20

(52) U.S. Cl. 475/231

(57) ABSTRACT

The present invention provides user-selectable locking differential having a carrier coupled to a ring gear. The carrier includes a differential case that supports side bevel gears, which mesh with bevel pinion gears. The differential gear train is lockable by moving a locking ring into engagement with one of the bevel gears. In one embodiment, an expandable membrane seated in an annular groove of the differential case operates to urge the locking ring into engagement with the bevel gear. In another embodiment, a cup having a low-friction surface is placed in the annular groove of the case and a piston moves relative to the cup to urge the locking ring into engagement with the bevel gear. In addition, the locking ring, bevel gear, and the differential case each have engagement features that advantageously reduce the amount of friction between these respective components.

### FIELD OF THE INVENTION

This invention relates generally to a limited slip or locking differential system having an actuation mechanism to generate a mechanical lock within the system.

### BACKGROUND OF THE INVENTION

Differentials for automotive-type applications are used in many front or rear axles to transmit the power from the engine to the driven wheels of the vehicle. There are a variety of differential types such as conventional or “open” differentials, limited slip differentials, and lockable or locking differentials. These types are distinguishable by how they handle various possible operating conditions.

Limited slip and locking differentials contain mechanisms and features which cause the differential to prevent or limit rotational speed differences between the left and right driven wheels. Different methodologies are used to actuate these mechanisms. The most common means for actuation of the mechanism in a locking differential are pneumatic, hydraulic, electric, electromechanical, or some combination thereof.

For those locking differentials that use pneumatic or hydraulic pressurized gases or fluids to actuate the mechanisms, frictional forces within the mechanism can require actuation pressures to become relatively high. These frictional forces are generated by friction between meshing parts, wear on actuation pistons, and other sources. As a result, these pneumatic or hydraulic locking differentials require more energy, which in turn makes them more costly to operate.

Consequently, there is a need for an improved differential that overcomes some or all of the aforementioned issues. For example, there is a need to reduce the friction in the differential locking mechanism, to minimize wear on the piston, and to reduce the start-up and working pressures to reduce the stress on the affected differential components.

### SUMMARY OF THE INVENTION

The present invention is generally related to a limited slip or locking differential for automotive and other related vehicles, for example, in low traction areas.

In one example of the invention, a differential gear system includes a locking ring having a plurality of first engagement features extending radially outward from a periphery and a plurality of second engagement features extending radially inward from an inner portion of the locking ring. The locking ring is located in a cavity formed in a differential case. A portion of the case includes a plurality of case engagement features that are complimentarily contoured to mesh with the first engagement features of the locking ring, and thus rotationally restrain the locking ring relative to the case. The differential gear system further includes at least one bevel gear having a plurality of engagement features extending from a periphery of the bevel gear. The bevel gear engagement features are configured to cooperatively engage the second engagement features of the locking ring when the locking ring is selectively moved into engagement with the bevel gear. Selectively moving the locking ring into engagement with the bevel gear is achieved with an actuation assembly that includes an expandable membrane or a piston/cup assembly placed in an annular groove in the case. During actuation, the locking ring urged into engagement with at least one of the bevel gears. Consequently, the locking ring, once engaged with the bevel gear, halts the rotational motion of the bevel gear relative to the case.

In another example of the invention, a differential system includes a locking ring having a plurality of first engagement features and a plurality of second engagement features. A differential case includes an annular groove and a plurality of engagement features complimentarily engageable with the first engagement features of the locking ring to rotationally restrain the locking ring. At least one bevel gear having a plurality of engagement features complimentarily engageable with the second engagement features of the locking ring when the locking ring is selectively moved into engagement with the bevel gear and an annular, expandable membrane positioned in the annular groove of the case. The expandable membrane has a fluid inlet and an outer surface contiguous with a portion of the locking ring. By expanding the membrane with a pressurized fluid, the locking ring is selectively urged into engagement with the at least one bevel gear to lock the differential system.

### BRIEF DESCRIPTION OF THE DRAWINGS

The sizes and relative positions of elements in the drawings or images may not necessarily be to scale. For example, some elements may be arbitrarily enlarged or otherwise modified to improve clarity. Further, the illustrated shapes of the elements may not convey their actual shapes, and have been solely selected for ease of recognition. Various embodiments are briefly described with reference to the following drawings:

FIG. 1 is a top, right isometric view of a differential system in a locked configuration according to one illustrated embodiment;

FIG. 2 is top, right isometric view of the differential system of FIG. 1 in an unlocked configuration;

FIG. 3 is a side elevational view of the differential system of FIG. 1;

FIG. 4 is a cross-sectional view of the differential system of FIG. 3 taken along line 4-4;

FIG. 5 is an exploded, isometric view of the differential system of FIG. 1;

FIG. 6A is a cross-sectional view of the differential system of FIG. 1 taken along line 6A-6A of FIG. 3;

FIG. 6B is an expanded view of the engagement between the locking ring and the differential case;

FIG. 7A is a cross-sectional view of the differential system of FIG. 1 taken along line 7A-7A of FIG. 3;

FIG. 7B is an expanded view of the engagement between the locking ring and the bevel gear;

FIG. 8 is a cross-sectional view of the differential system of FIG. 1 in an unlocked state where the locking ring is biased in the unlocked state;

FIG. 9 is a cross-sectional view of the differential system of FIG. 1 in an locked state where the locking ring has been urged into engagement with the bevel gear by an expandable membrane;

FIG. 10 is a side elevational view of a differential system having a piston and cup type of locking actuation system, according to another embodiment; and

FIGS. 11 is a cross-sectional view of the differential system of FIG. 10 taken along line 11-11.

### DETAILED DESCRIPTION OF THE INVENTION

One preferred example of the invention takes the form of a user selectable locking differential for an automotive or other type of motorized vehicle. The user selectable lockable differential advantageously includes an actuation system that requires less power during a lock/unlock operation and is expected to have a longer operational life. In one embodiment, the actuation system includes an expandable membrane situated in a groove formed in the case of the differential. The expandable membrane may be in direct contact with the locking ring and has minimal relative motion with respect to the case (i.e., virtually static). In another embodiment, the actuation system includes a cup or a sleeve made out of a low-friction material. The cup is positioned (e.g., shrink or press fit) into the groove formed in the case of the differential. A piston seals with and moves relative the cup to urge a locking ring from an unlocked to a locked state.

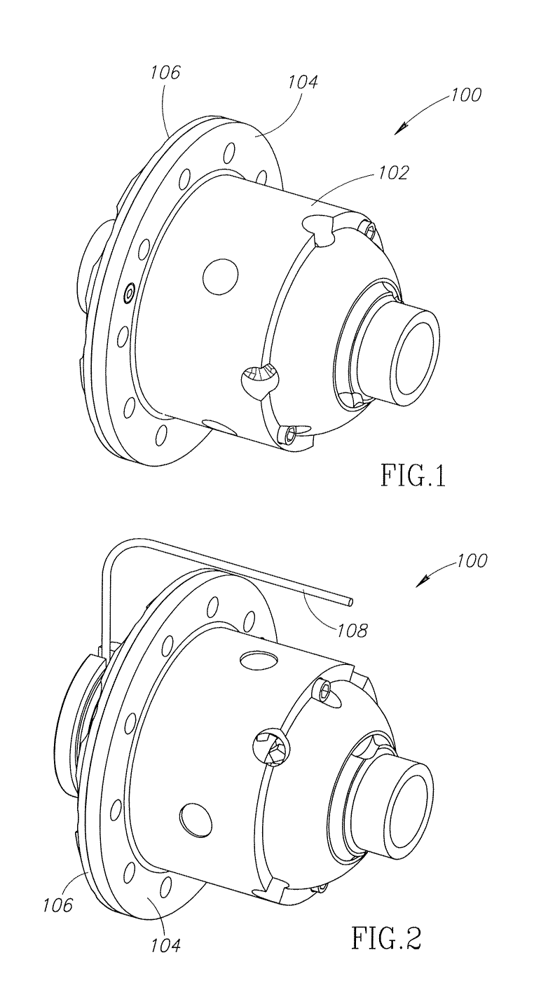

FIGS. 1 and 2 show a differential 100 having a main case body 102 with a first flange 104 secured to a main case cover 106. The main case body 102 through the first flange 104 may be bolted or otherwise fastened to the main case cover 106 to form at least one cavity therein. FIG. 1 shows the differential in a locked configuration while FIG. 2 shows the differential in an unlocked configuration. Also in FIG. 2 is a fluid inlet tube 108 for transmitting pressurized fluid to the locking actuation system.

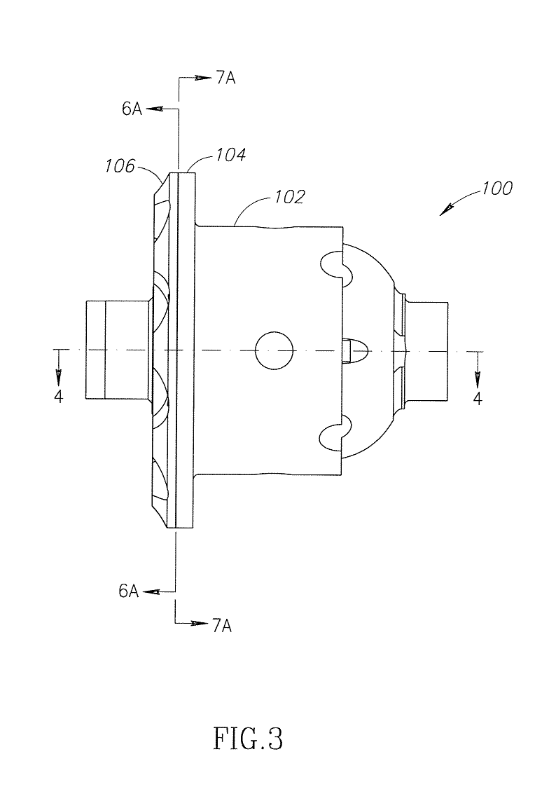

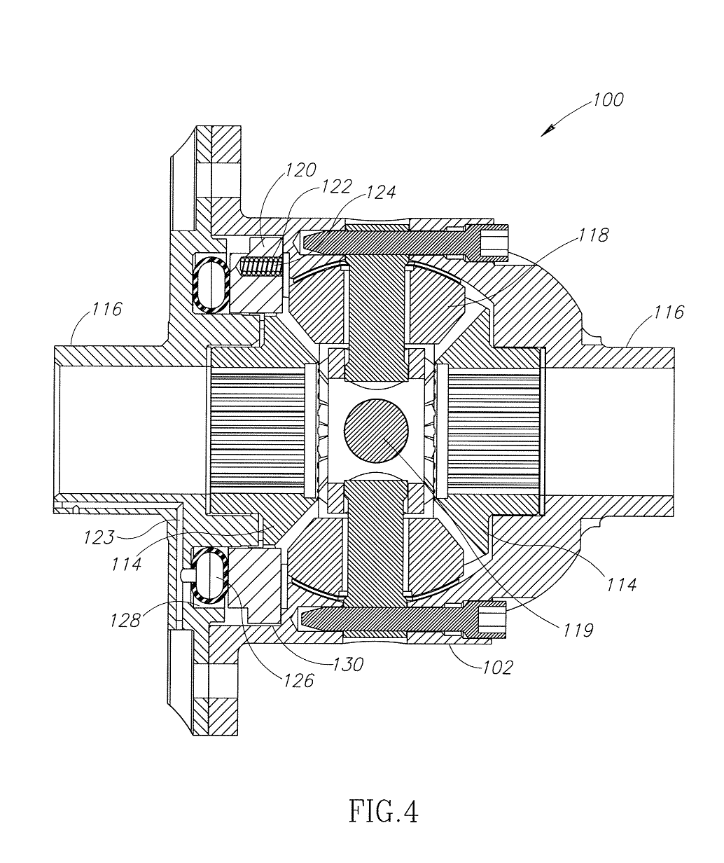

Referring to FIGS. 3 and 4, FIG. 4 shows the internal components of the differential 100 in a locked state. The case 102 includes sleeves 116 sized to receive a shaft (not shown), such as an externally splined axle shafts, through the inner diameter of 116 to couple to wheels of a vehicle. Within the cavity of the case 102 are bevel side gears 114 configured to engage axle shafts coupled to the wheels of a vehicle. Power supplied to the differential 100 causes the wheels of the vehicle to rotate. Pinion gears 118 meshably engage with the bevel gears 114. The pinion gears 118 are coupled to the case 102 with a cross pin 119. Generally, but not always, the pinion gears 118 have fewer gear teeth than the bevel gears 114.

A slideable, annular locking ring 120 is located between at least one of the bevel gears 114 and the case 102. By way of example in the illustrated embodiment, the locking ring 120 is positioned toward the left-hand side of the case 102, but it is appreciated that the locking ring may be positioned toward the right-hand side of the case 102 or possibly extend across the case such that portions of the locking are on both sides of the case 102. A biasing member 122, such as a compression spring, is seated against a portion 124 of the case 102 and biases the locking ring 120 into an unlocked state.

An annular, expandable membrane 126 is sized to fit in an annular groove or channel 128 formed in the case 102, such as in the main case cover 106 by way of example. The case 102 includes a passageway 123 in fluid communication with the membrane 126. The fluid may be either gas, such as air, or liquid (i.e., pneumatic or hydraulic). Expanding the membrane 126 causes the locking ring 120 to slidably translate and engage one of the bevel gears 114 while remaining engaged with a complimentary portion 130 of the case 102.

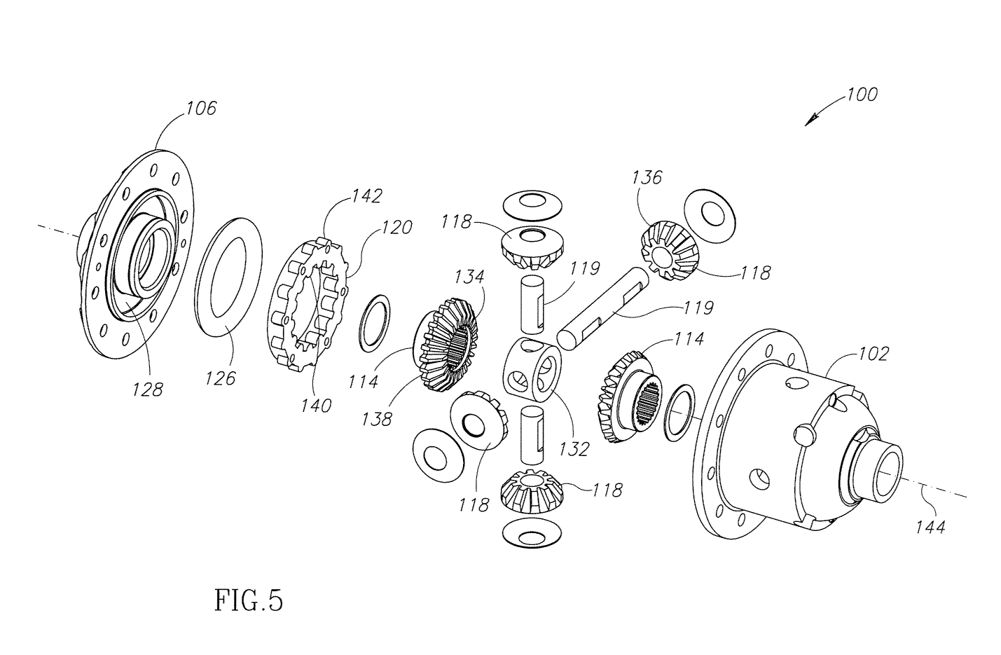

FIG. 5 shows an exploded view of the differential 100. In the illustrated embodiment, four pinion gears 118 are coupled via cross pins 119 to a center hub 132. Two bevel gears 114 have gear teeth 134 configured to meshably engage with respective pinion gear teeth 136. The two bevel gears 114 will be referred to as the left side and right side bevel gear 114, respectively, where the left side bevel gear 114 operates to engage the locking ring 120 when the differential 100 is selectively locked.

In one embodiment, at least the left side bevel gear 114 includes engagement features 138 formed about a periphery of the left side bevel gear 114. In the illustrated embodiment, the engagement features 138 take the form of semi-elliptical cavities or wells 138. For cost and machining efficiency, both the left side bevel gear and the right side bevel gear will preferably be identical, even though only one of the bevel gears 114 need operatively cooperate with the locking ring 120 in the case 102. However, it is understood and appreciated that the bevel gears 114 do not have to be structurally identical.

The locking ring 120 includes inner engagement features 140 and outer engagement features 142. The inner engagement features 140 extend from an inner diameter of the locking ring 120 and take the form of semi-elliptical protrusions in the illustrated embodiment. The outer engagement features 142 extend from a periphery of the locking ring 120 and also take the form of semi-elliptical protrusions. The particular shape of the engagement features may vary, but should enable engagement with the bevel gear 114 and case 102.

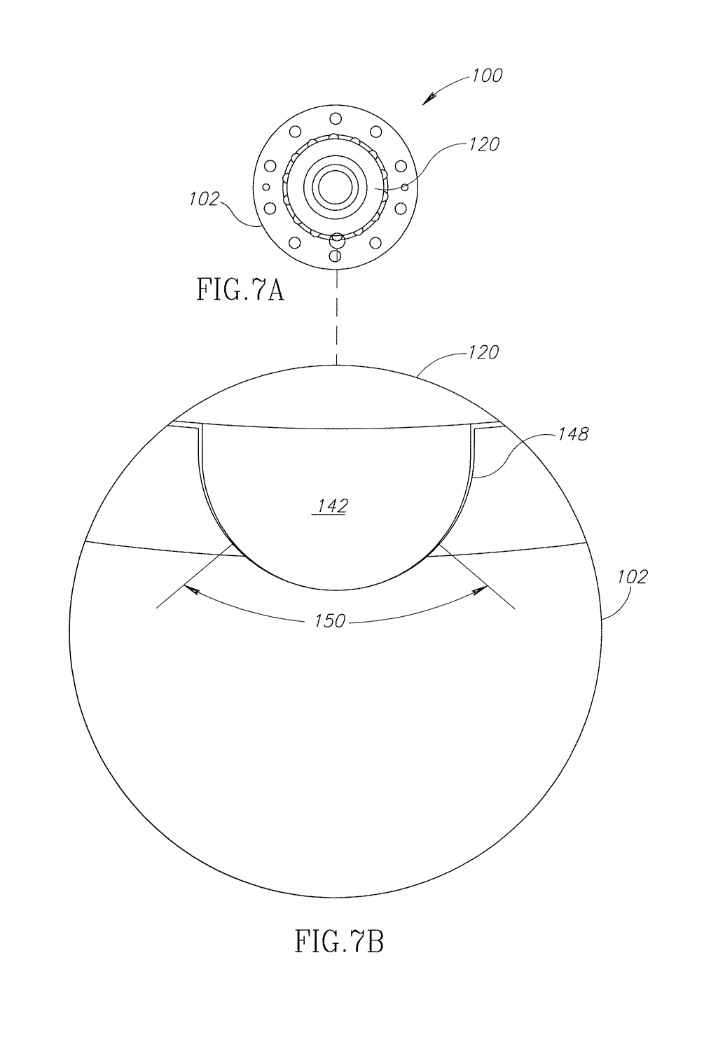

When the differential is selectively locked, the locking ring 120 is slideably urged along a longitudinal axis 144 by the membrane 126 located in the groove 128 of the main case cover 106 such that the bevel gear engagement wells 138 complimentarily mesh with the inner engagement protrusions 140 of the locking ring 120. The locking ring 120 remains rotationally fixed with respect to the case 102 because the outer engagement features 142 remain engaged with complimentary engagement features 148 (FIG. 7B) formed within the case 102. In addition, the size and configuration of the membrane 126 advantageously permits the membrane 126 to be repeatedly expanded and compressed with minimal, if any, relative sliding contact between the membrane 126 and the groove 128 of the main case cover 106 (FIG. 5). The membrane expands along the axis 144 (FIG. 5) and the cross section thins out with respect to the groove 128 so that it no longer touches the groove 128. The membrane 126 may be made from an elastomer material, for example Nitrile or Viton. Preferably, the membrane 126 is actuated with compressed air; however other types of gases may be used, for example compressed CO2.

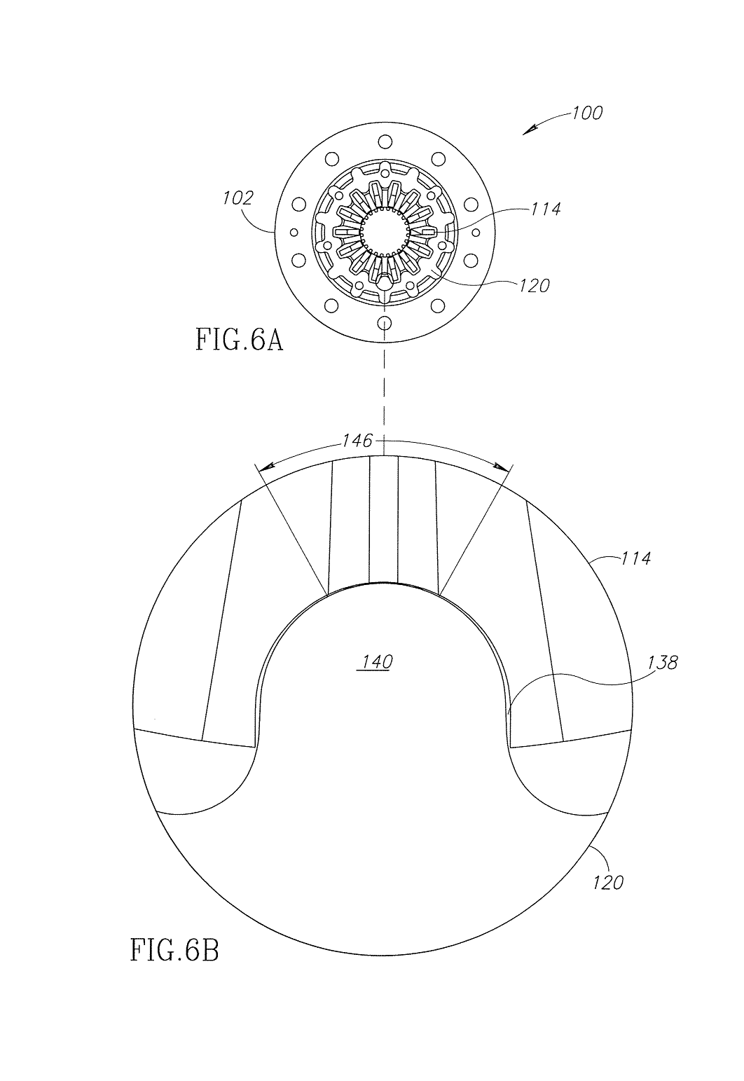

FIGS. 6A and 6B show the locking ring 120 engaged with the bevel gear 114. Referring to FIG. 6B, the inner engagement protrusion 140 of the locking ring 120 is engaged with a corresponding well 138 of the bevel gear 114. The walls forming the well 138 may be slightly flared, such that the inner engagement protrusion 140 of the locking ring 120 makes surface-to-surface contact with only a limited region 146 of the well 138. In addition, a depth of the well 138 is sufficient to receive a substantial portion of the inner engagement protrusion 140 of the locking ring 120. Consequently, the amount of surface-to-surface contact between the locking ring 120 and the bevel gear 114 is minimized to reduce friction and wear.

FIGS. 7A and 7B show the locking ring 120 engaged with the case 102. As previously mentioned, the case 102 includes engagement features 148 that take the form of cavities or wells. In one embodiment, the engagement features 148 take the form of semi-elliptical wells. The walls forming the well 148 may be slightly flared as described above with respect to the wells 138 of the bevel gear 114. Likewise, the cooperating profiles or contours of the locking protrusion 142 and the case well 148 operate to minimize the surface-to-surface contact as indicated by a limited contact region 150.

Although the engagement features of the various components are shown with semi-elliptical profiles, the engagement features are not limited to this type of profile. The engagement features may have semi-circular profiles, for example. The purpose of the semi-elliptical profile is to reduce the amount of surface-to-surface contact between the respective components, which in turn reduces friction and wear, and ultimately reduces the amount of power needed to move the locking ring 120 from an unlocked to a locked state and vice-versa.

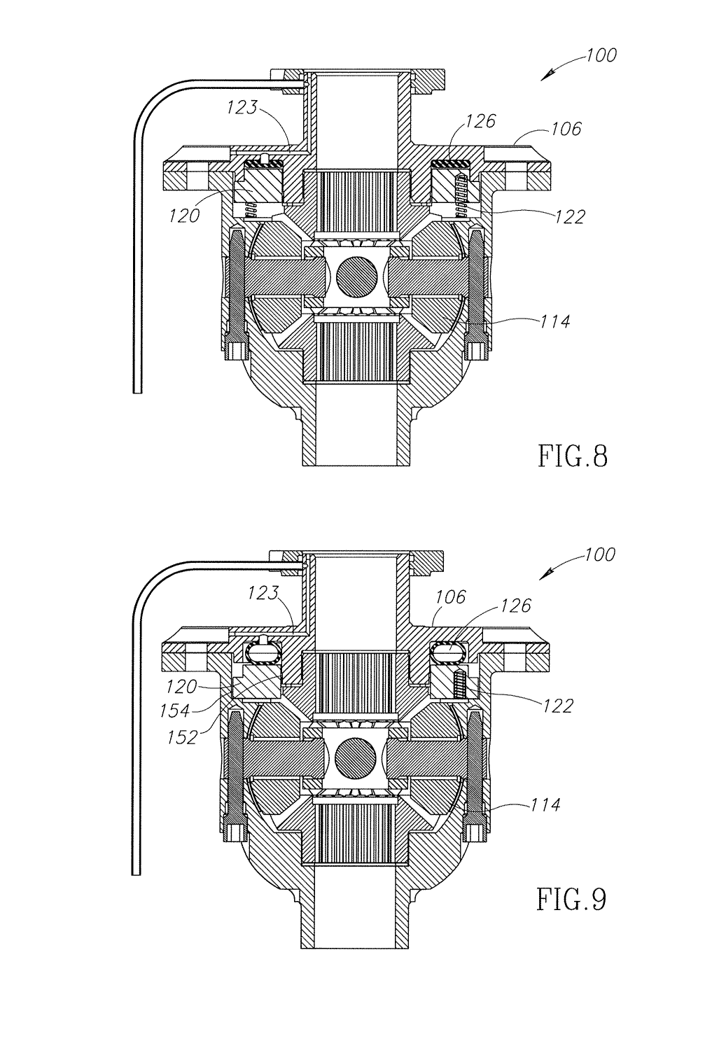

FIGS. 8-10 will now be used to describe the operation of the differential 100. FIG. 8 shows the differential 100 in an unlocked state with the membrane 126 compressed. In the unlocked state, the biasing member 122 biases the locking ring 120 against the main case cover 106. The inner engagement features 140 (FIG. 6B) of the locking ring 120 are not engaged or in contact with the corresponding wells 138 (FIG. 6B) of the bevel gear 114. Thus, in the unlocked state, the differential operates in a conventional fashion allowing one wheel of the vehicle to slip or rotate relative to the other wheel.

FIG. 9 shows the differential 100 in a locked state. To lock the differential 100, a pressurized fluid, such as air, is introduced through the passageway 123 to expand the membrane 126. The expanded membrane 126 overcomes the biasing force of the biasing member 122 and urges the locking ring 120 axially away from the main case cover 106. As the locking ring 120 moves, the locking ring engagement features 140 (FIG. 6B) engage the bevel gear engagement features 138 (FIG. 6B). As illustrated in FIG. 9, the locking ring 120 has engaged the bevel gear 114 along an interface 152. In addition, the locking ring 120 remains engaged with the case 102 along interface 154. The locking ring 120 is sufficiently wide to permit the locking ring 120 to stay rotationally fixed to the case 102 while slideably engaging or meshing with the bevel gear 114. Accordingly, the engagement of the locking ring 120 to both the bevel gear 114 and the case 102 establishes a mechanical lock between the bevel gear 114 and the case 102 via the locking ring 120. The pressurized fluid must be maintained in the membrane 126 in order to keep the differential 100 in the locked state.

To unlock the differential 100, the pressurized fluid is bled off or removed from the membrane 126. The biasing member 122 then urges the locking ring 120 back toward the main case cover 106 and out of engagement with the bevel gear 114.

The differential 100 advantageously provides a self contained, reduced friction actuation locking assembly. By minimizing the amount of surface between the bevel gear, locking ring, and the case, respectively, these components will have a longer life expectancy. The reduced friction, in addition, permits the differential to be locked and unlocked using less power.

The expandable membrane is advantageously subjected to no external wear due to the absence of sliding contact with the walls of the groove in the differential case. This reduces the cost and time to make the case because the surface of the groove may be left fairly “rough” and is insensitive to minor casting flaws.

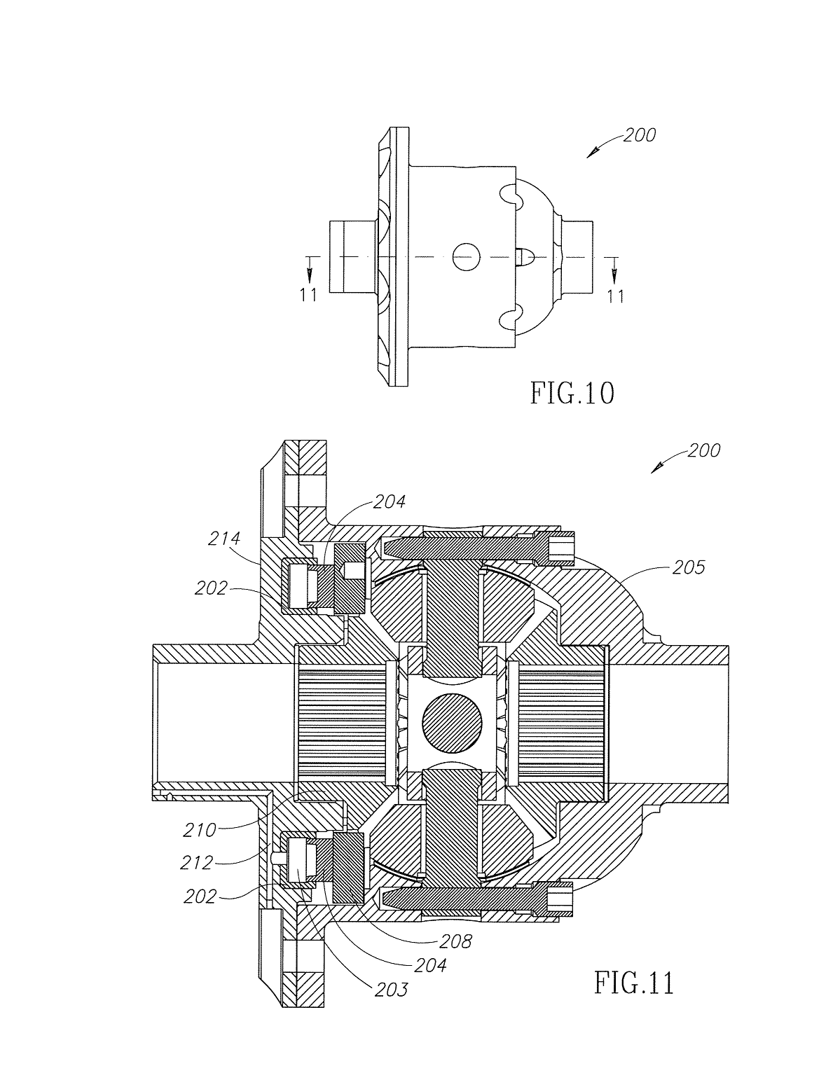

FIGS. 10 and 11 show a differential 200 in a locked state according to another embodiment of the invention. In this embodiment, the expandable membrane 126 is replaced with a low-friction member, such as a sleeve or cup 202 and a metallic piston 204. The cup 202 is arranged in a rough machined groove 203 of the differential case 205. Preferably, the cup 202 is made from Teflon or some other self-lubricating plastic material. The structural configuration and operation of the differential 200 is quite similar to the differential 100 described above. As such, the description herein addresses only aspects of the differential 200 that are substantially different from the differential 100.

Referring to FIG. 11, the piston 204 is configured to slideably and sealingly move relative to the cup 202 and thus move the locking ring 208 into engagement with the bevel gear 210. By transmitting a pressurized fluid, such as air, into a passageway 212, the piston 204 is urged away from the main case cover 214 and into engagement with the bevel gear 210 while overcoming a biasing force from a biasing member (not shown). After the locking ring 208 has fully, or at least adequately, engaged the bevel gear 210 to achieve a mechanical lock, the piston 204 remains sealed with respect to the cup 202. The pressurized fluid may then be bled off or removed from a space 203 between the piston 204 and the cup 202 to unlock the differential 200.

Many other changes can be made in light of the above detailed description. In general, in the following claims, the terms used should not be construed to limit the invention to the specific embodiments disclosed in the specification and the claims, but should be construed to include all types of differentials, gears, gear systems, actuation systems, and differential cases that operate in accordance with the claims. Accordingly, the invention is not limited by the disclosure, but instead its scope is to be determined entirely by the following claims.

What is claimed is:

1. A differential gear system comprising:
a locking ring having a plurality of first engagement features on a peripheral portion of the locking ring and a plurality of second engagement features on an inner portion of the locking ring;
a differential case having a plurality of engagement features configured to cooperatively engage the first engagement features of the locking ring to rotationally restrain the locking ring;
a bevel gear having a plurality of engagement features configured to cooperatively engage the second engagement features of the locking ring; and
an actuation assembly to selectively move the locking ring relative to the case and into engagement with the at least one bevel gear to rotationally restrain the bevel gear relative to the case.

2. The differential gear system of claim 1, wherein the plurality of first and second engagement features on the locking ring are semi-elliptical protrusions.

3. The differential gear system of claim 1 wherein the plurality of engagement features of the case are complimentarily configured to mesh with the first engagement features of the locking ring.

4. The differential gear system of claim 1, wherein the plurality engagement features of the bevel gear are complimentarily configured to mesh with the second engagement features of the locking ring.

5. The differential gear system of claim 1, wherein the actuation assembly includes a piston forming a seal with an annular cup device located in an annular groove of the case, the piston selectively moveable to urge the locking ring into engagement with the bevel gear.

6. The differential gear system of claim 1, wherein the actuation assembly includes an expandable membrane received in an annular groove of the case and in contact with the locking ring.

7. The differential gear system of claim 6, wherein the locking ring is biased in an unlocked position until the expandable membrane becomes sufficiently inflated to cause engagement of the locking ring with the bevel gear.

8. A differential system comprising:
a locking ring having a plurality of first engagement features and a plurality of second engagement features;
a differential case having a plurality of engagement features complimentarily engageable with the first engagement features of the locking ring to rotationally restrain the locking ring;
a bevel gear having a plurality of engagement features complimentarily engageable with the second engagement features of the locking ring when the locking ring is selectively moved into engagement with the bevel gear; and
an expandable membrane positioned in the case, the expandable membrane having a fluid inlet and an outer surface adjacent a portion of the locking ring, wherein expansion of the expandable membrane with a pressurized fluid urges the locking ring into engagement with the bevel gear to lock the differential system.

9. The differential system of claim 8, wherein the plurality of first engagement features and the plurality of second engagement features on the locking ring are semi-elliptical protrusions extending from an outer and an inner surface of the locking ring.

10. The differential system of claim 8, wherein the differential case includes an annular groove.

11. The differential system of claim 10, wherein the expandable membrane is positioned within the annular groove of the differential case.

12. The differential system of claim 8, wherein the expandable membrane is a bladder.
